(19) United States
(12) Patent Application Publication
(10) Pub. No.: US 2010/0214222 A1
(43) Pub. Date: Aug. 26, 2010

(54) TOUCHPAD MOUSE WAKEUP CIRCUIT ARRANGEMENT

(75) Inventor: Hung-Che YEN, Taipei City (TW)

Correspondence Address: Muncy, Geissler, Olds & Lowe, PLLC, 4000 Legato Road, Suite 310, FAIRFAX, VA, 22033, US

(73) Assignee: CHANCE STEEL MOLD CO., LTD., Tucheng City (TW)

(21) Appl. No.: 12/710,854

(22) Filed: Feb. 23, 2010

(30) Foreign Application Priority Data
Feb. 26, 2009 (TW) 098202897

(51) Int. Cl. G06F 3/033

(52) U.S. Cl. 345/163

(57) ABSTRACT

A touchpad mouse wakeup circuit arrangement is disclosed to include a control circuit installed in a touchpad mouse and consisting of a microprocessor, a touch panel, a vibration sensor and a power supply module. The vibration sensor detects a micro vibration and provides a voltage signal to the microprocessor when a user touches the housing of the touchpad mouse, causing the microprocessor to output a triggering signal to wakeup the touchpad mouse and to start the power supply module.

The application claims the priority benefit of Taiwan application number 098202897 filed on Feb. 26, 2009.

### BACKGROUND OF THE INVENTION

1. Field of the Invention

The present invention relates to touchpad mice and more particularly, to a touchpad mouse wakeup circuit arrangement, which produces a triggering signal to wakeup the touchpad mouse and to start a power supply module to provide the necessary working power supply when a person touches or clicks the housing of the touchpad mouse, saving power consumption.

2. Description of the Related Art

Regular personal computers and notebook computers are commonly equipped with a keyboard and a mouse for signal input. When compared to a keyboard, a mouse is more convenient for moving a cursor on a screen. In a computer operation system, the mouse is a requisite equipment. Many application programs must be operated through a mouse. A mouse facilitates the operation of a computer system.

Further, conventional mice include mechanical mice and optical mice. A mechanical mouse uses a trackball for rolling by the user. The trackball of a mechanical mouse consists of a ball held by a socket and sensors to detect a rotation of the ball in X-axis and Y-axis direction and to send the detected result to the computer. An optical mouse uses light-emitting diodes and photodiodes to detect movement relative to the underlying surface. Modern surface-independent optical mice work by using an optoelectronic sensor to take successive images of the surface on which the mouse operates. An advanced mouse has image-processing chips embedded therein to detect relative motion on a wide variety of surfaces, translating the movement of the mouse into the movement of the pointer and eliminating the need for a special mouse-pad. Nowadays, touchpad is used in a computer mouse. A touchpad consists of specialized surface that can translate the motion and position of a user's fingers to a relative position on screen. When a touchpad is used with a gesture recognition software and a word bank, a touchpad is practical for browsing and searching songs, dialing a telephone number, sending an e-mail message, or operating other functions, providing a human-friendly environment.

Further, wireless mice have been intensively used in personal computers as well as notebook computers to substitute for conventional wired mice. A wireless mouse eliminates a cable connection. A wireless mouse has a wireless transmitter mounted therein for transmitting a wireless signal to a wireless receiver installed in the computer, and is equipped with a battery that provides the wireless mouse with the necessary working voltage. However, a wireless mouse keeps consuming power supply from the equipped battery during the time period the user does no work. Thus, the battery of a wireless mouse will be used up soon. When power low, the battery must be recharged, or replaced with a new battery. In order to save power consumption, a time control circuit is created for use in a mouse to save power consumption. When the user stops input, the time control circuit starts to count time and then switches the mouse into the standby mode after a predetermined length of time within which no any operation signal is detected. When the mouse is moved or operated, a wakeup signal is created to wake up the mouse for operation. However, the mouse keeps consuming the power supply before entering the standby mode or during automatic displacement sensing or operation. Further, when the user operates the mouse during the standby mode, the mouse cannot make a response on the real time and will be wakened up after a time delay, lowering the operation efficiency and effects.

Therefore, it is desirable to provide a measure that eliminates the aforesaid problems.

### SUMMARY OF THE INVENTION

The present invention has been accomplished under the circumstances in view. It is one object of the present invention to provide a touchpad mouse wakeup circuit arrangement, which makes the touch control effective only when the user touches or clicks the housing of the touchpad mouse during a touch operation to touch the touch panel of the touchpad mouse. When the user touches or clicks the housing of the touchpad mouse, a vibration sensor of an induction loop of the touchpad mouse wakeup circuit arrangement senses a micro vibration and converts the micro vibration into a voltage signal for causing a microprocessor to output a triggering signal to wake up the touchpad mouse and to start a power supply module that provides the touchpad mouse with the necessary working voltage. If the user does not touch or click the housing of the touchpad mouse, the touch function is inactive, and the touchpad mouse is kept in the standby mode.

Further, if the user does not touch or click the housing of the touchpad mouse when the touchpad mouse is in the standby mode, the vibration sensor of the induction loop in the touchpad mouse detects no signal and the power supply module is kept off, avoiding an erroneous operation.

Further, when the user touches or clicks the housing of the touchpad mouse, the induction loop wakes up the touchpad mouse and synchronously starts the power supply module to provide the necessary working voltage for operation. Thus, the touchpad mouse wakeup circuit module saves power consumption, extends the operating time, makes a synchronous response, and enhances the functioning of the touchpad mouse.

### BRIEF DESCRIPTION OF THE DRAWINGS

FIG. 1 is a circuit block diagram of a touchpad mouse wakeup circuit arrangement in accordance with the present invention.

FIG. 2 is an elevational view of a touchpad mouse constructed in accordance with the present invention.

FIG. 3 is an exploded view of the touchpad mouse shown in FIG. 2.

### DETAILED DESCRIPTION OF THE PREFERRED EMBODIMENT

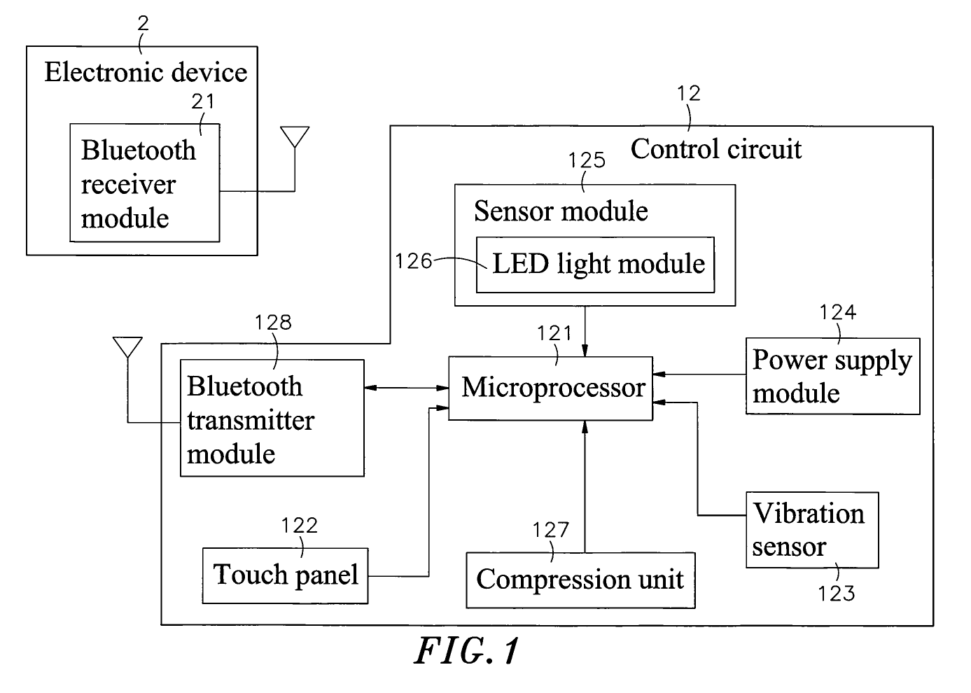

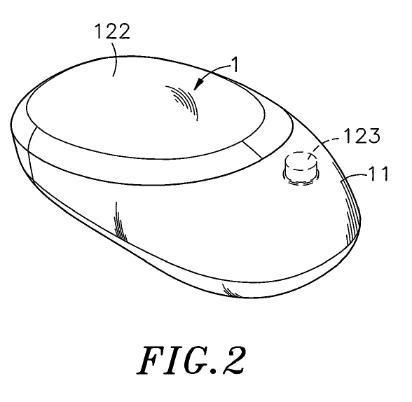

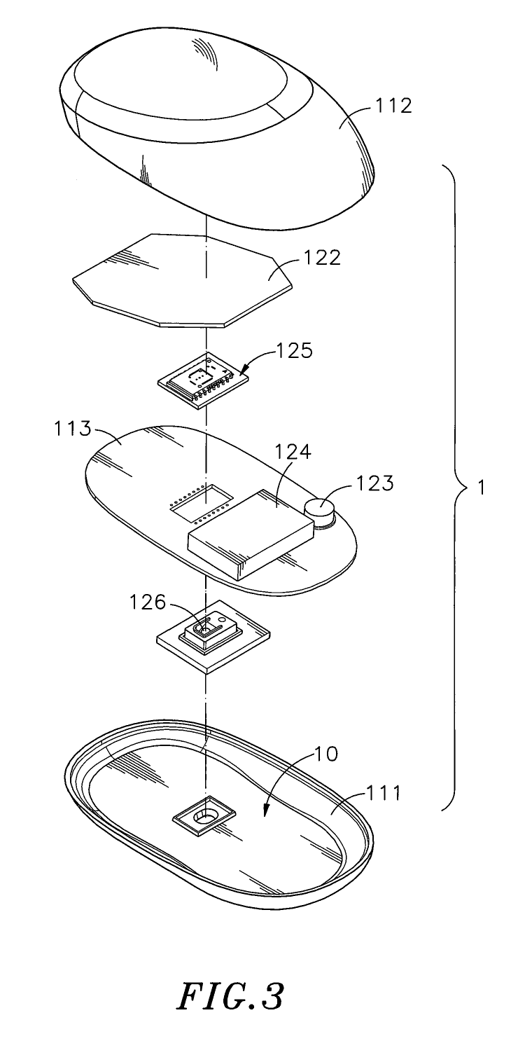

Referring to FIGS. 1-3, a touchpad mouse 1 is shown comprising a housing 11 and a control circuit 12 mounted inside the housing 11.

The housing 11 comprises a bottom cover shell 111, a top cover shell 112 covering the bottom cover shell 111, an accommodation chamber 10 defined in between the bottom cover shell 111 and the top cover shell 112 and at least one circuit board 113 accommodated in the accommodation chamber 10. The circuit board 113 has electronic components and the control circuit 12 arranged thereon.

The control circuit 12 comprises a microprocessor 121, a touch panel 122, a vibration sensor 123 and a power supply module 124. The microprocessor 121 is electrically connected with the touch panel 122, the vibration sensor 123 and the power supply module 124. The vibration sensor 123 can be a piezoelectric vibration sensor, mechanical vibration sensor or G-sensor adapted to provide a vibration sensing, displacement sensing, motion sensing or tilt sensing function. Further, the microprocessor 121 has electrically connected thereto a sensor module 125. The aforesaid components are assembled, forming the touchpad mouse 1.

During the use of the touchpad mouse 1, the control circuit 12 forms an induction loop in the housing 11. When a user touches the surface of the touch panel 122 to initiate a touch function, the user needs to touch the housing 11 with the hand or to click the housing 11 with a finger, thereby producing a micro vibration or displacement to trigger the induction loop, thus, the touch function becomes effective. Further, the vibration sensor 123 converts the amount of displacement into a voltage signal and transmits the voltage signal to the microprocessor 121 for calculation so that the microprocessor 121 outputs a triggering signal to wake up the stand-by touchpad mouse 1 and to start the power supply module 124 to provide the necessary working power supply. In other words, if the human body does not touch the housing 11 of the touchpad mouse 1, the touch control function of the touch panel 122 is inactive, the microprocessor 121 does not output any triggering signal, and the touchpad mouse 1 is kept in the standby mode.

The aforesaid sensor module 125 of the control circuit 12 that is electrically connected to the microprocessor 121 can be an infrared sensor module, CMOS (complementary metal-oxide semiconductor) image sensor or CCD (charge-coupled device) image sensor. Further, the sensor module 125 works with a LED light module 126 for calculating the amount of displacement of the touchpad mouse 1 on a flat surface by means of measuring the pulse wave of the light emitted by said light-emitting diode means and reflected by said flat surface. Further, when the user touches the touch panel 122 that is exposed to the outside of the housing 11, a corresponding analog signal is produced and transmitted to the microprocessor 121 for conversion into a corresponding digital signal. This digital signal is then sent by the microprocessor 121 to a compression unit 127 for compression so that the compressed digital signal can be then transmitted to a Bluetooth receiver module 21 of an external electronic device 2 by a Bluetooth transmitter module 128 of the touchpad mouse 1 for causing the external electronic device 2 to execute the corresponding command or program. The displacement sensing and calculation operations of the sensor module 125 and the touch control function of the touch panel 122 are of the known art and not within the scope of the present invention, and therefore no further detailed description in this regards is necessary.

As stated above, the main feature of the present invention is the arrangement of the circuit board 113 that carries the control circuit 12 and the related electronic components. The microprocessor 121 of the control circuit 12 is electrically connected with the touch panel 122, the vibration sensor 123 and the power supply module 124. When a person touches the touch panel 122 to run a touch function, the user needs to touch or click the housing 11 to create a micro vibration displacement, triggering the induction loop. Further, the vibration sensor 123 converts the amount of micro vibration displacement into a corresponding voltage signal and transmits this voltage signal to the microprocessor 121 for causing the microprocessor 121 to output a triggering signal to wake up the touchpad mouse 1 and to start the power supply module 124. This touchpad mouse wakeup arrangement avoids the touchpad mouse 1 from wasting power supply before entering the standby mode or during automatic displacement sensing or operation, thereby extending the effective operating time of the touchpad mouse 1. Further, this arrangement makes a response synchronously upon touch of the housing 11 by the user, avoiding wakeup delay.

Further, if the housing 11 is not touched or clicked by a human body during the standby mode of the touchpad mouse 1, no any micro vibration displacement is created to trigger the induction loop. At this time, the vibration sensor 123 detects no signal to wake up the touchpad mouse 1, and the power supply module 24 is off. Therefore, the invention avoids an erroneous operation, saves power consumption, extends the operating time, makes a synchronous response, and enhances the functioning of the touchpad mouse 1.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A touchpad mouse wakeup circuit arrangement, comprising:
a housing defining therein an accommodation chamber;
a circuit board accommodated in said accommodation chamber; and
a control circuit installed in said circuit board, said control circuit comprising a microprocessor, a touch panel exposed to the outside of said housing and electrically connected to said microprocessor, a vibration sensor electrically connected to said microprocessor and a power supply module electrically connected to said microprocessor;
wherein said control circuit forms an induction loop such that when a user touches said housing to create a micro vibration, said vibration sensor detects said micro vibration and causes said induction loop to produce a voltage signal to said microprocessor for enabling said microprocessor to output a triggering signal to wakeup the touchpad mouse and to start said power supply module.

2. The touchpad mouse wakeup circuit arrangement as claimed in claim 1, wherein said vibration sensor is selected from a group consisting of piezoelectric sensor, mechanical vibration sensor and G-sensor.

3. The touchpad mouse wakeup circuit arrangement as claimed in claim 1, wherein said control circuit further comprises a sensor module electrically connected to said microprocessor and adapted to sensing displacement of the touchpad mouse on a flat surface, a compression unit electrically connected to said microprocessor and adapted to compress a digital signal converted by said microprocessor from an analog signal produced by said touch panel upon touch of a person, a Bluetooth transmitter module electrically connected to said microprocessor and controllable by said microprocessor to transmit compressed digital signal obtained from said compression unit to a Bluetooth receiver of an external electronic device.

4. The touchpad mouse wakeup circuit arrangement as claimed in claim 3, wherein said sensor module is an infrared sensor module working with light-emitting diode means to calculate the amount of displacement of the touchpad mouse on a flat surface by means of measuring the pulse wave of the light emitted by said light-emitting diode means and reflected by said flat surface.
